(19) United States
(12) Patent Application Publication
(10) Pub. No.: US 2002/0094026 A1
(43) Pub. Date: Jul. 18, 2002

(54) Video super-frame display system

(76) Inventor: Steven D. Edelson, Wayland, MA (US)

Correspondence Address: VENABLE, BAETJER, HOWARD AND CIVILETTI, LLP, P.O. BOX 34385, WASHINGTON, DC, 20043-9998, US

(21) Appl. No.: 10/025,888

(22) Filed: Dec. 26, 2001

Related U.S. Application Data
(60) Provisional application No. 60/260,919, filed on Jan. 12, 2001.

(51) Int. Cl. H04N 7/12

(52) U.S. Cl. 375/240.01; 348/700

(57) ABSTRACT

In a video display system, a video is divided into scenes at scene cuts and the scenes are divided into subsequences of uniform duration. The sub sequences are combined into composites called super-frames, which are compressed. The compressed super-frames are played back by being decompressed and the video frames are derived from the super-frames to achieve a simulated version of the original video.

The benefit of co-pending provisional application Ser. No. 60/260,919 filed Jan. 12, 2001 entitled Video Super-Frame Animation is claimed.

This invention relates to an improved system for transmitting visual data with reduced bandwidth requirements for advertising, educational and other applications which do not require depiction of a substantial amount of action.

Background

Video motion pictures are being transmitted over low-bandwidth channels such as Internet modems and new cellular phone connections. Depending on the bandwidth and subject matter, the results can vary but are rarely satisfactory. A video motion picture is composed of many individual pictures (frames) displayed rapidly (15 to 30 per second). In a constrained bandwidth, the more images that are required to be sent, the less bandwidth that can be allocated to the encoding of each image. Accordingly, the quality of the images falls with the reduction of bandwidth available to each. If fewer images can be sent, they will be higher quality, but the action illusion of the video is lost when the frame rate is lower than 15 frames per second. It then becomes a jerky video or even appears as a sequence of stills.

While some applications truly require a video motion picture (e.g. showing Hollywood productions), many commercial sites are using video to accomplish a sales or information goal, in applications in which a conventional video motion picture is not required to achieve the information goal. Since it is the sales (or educational) information that is the goal, to accomplish the mission over low bandwidth, non-video methods are often chosen.

One popular technique uses a “look-around” photograph that allows the user to change their point of view within a panoramic photo by directing the viewing software via keyboard or mouse. The photographs can be 360-degree horizontal scenes—as if you were to look all around you at a particular spot. One such product is “Zoom” by MGI of Toronto Canada. Others, such as those by Ipix of Knoxville, Tenn., are more elaborate and allow the user to direct their view up and down as well as horizontally. Ipix also has a video product in which each frame is a 360-degree frame allowing the user to look left, right, up or down as the video is playing. These 360-degree images are made in different ways, sometimes including wide angle of fish-eye lenses, but usually involve “stitching” together two or more stills to complete the wide image. Although it is tricky to match up the images, the matching is being accomplished.

Another popular technique is the use of animations and a smart player. This system, typified by Macromedia Flash, sends compact coded descriptions of geometric shapes along with explicit instructions on how the play back unit should animate the shapes. For instance, a snowman might be drawn with a series of white disks (body), a set of black disks (buttons, eyes, nose) and an arc (smile). These descriptions of the shapes can be quite small in the amount of data required compared with the explicit description of all the pixels which would be required for a photographic transmission of the snowman as a conventional video motion picture. Further, animation of the snowman might be accomplished by instructions to move the eyes in some pattern—change the mouth shape, etc. These animation instructions are much more compact than the video animation technique which requires sending many frames per second with the new images. While the multiple video images of a video animation can be compressed taking advantage of the similarities in the video images, even with the compression, the video animation is much less compact than the graphic items plus animation instructions. A geometric animation system as described above relies on having an intelligent receiver which can draw the geometric shapes and move them in the requested movement patterns and speeds, but this is not a computationally difficult task and it works quite well in practice.

There are two drawbacks to this geometric animation system as compared to a video system. First, the geometric system is limited to geometric shapes and lacks photographic versatility. While it is true that top-end games and Hollywood artists can synthesize quite complex scenes and characters, it is still not the same as a video of an actual person or place. The second major drawback is somewhat connected to the first. It has to do with the creation process. To create a video, a camera and perhaps some editing software are employed. If the subject matter is available, this method is a quick and easy way to capture quite difficult imagery—for example a hotel lobby, building or even a car for sale. Although top design firms can, and do, program simulators to represent such images, such programming is beyond all but the most talented people with ample budget. On the other-hand, an amateur with a quality consumer camera and patience can do an adequate job of capturing the essence of these difficult images complete with “animation”, as he walks around, zooming in and out and panning his camera.

### INVENTION SUMMARY

This invention bridges the gap between the geometric animation systems and the video systems in a new type of system designed to convey visual information with apparent motion. It is created with commercial or educational missions in mind, but will be also useful for other missions, such as entertainment.

The invention comprises two sub-systems. One inputs a standard video source and prepares a set of image super-frames each of which is a composite of several source video frames. The system composites the video into these “super-frames” to allow the system to send fewer images to increase the quality of the received images. The super-frames may be some seconds apart in the play back sequence. The system will further detect and use the original video camera motions to generate commands to assist in the recreation of the many video frames from the few super frames. These commands will include selecting sub-regions of the super-frame to show magnifications of the region(zoom), inclination of the region (rotation), or even distortion of the region (projections). Macro instructions may compress the description of camera motion over a series of regions into an explicit camera motion, such as “Pan Right at 20 pixels per output frame for 100 frames.” Since the super-frames are separated in time, successive sequences based on successive super-frames may have a visible mismatch. The transition between one sequence of frames and the next sequence of frames can be softened by creating overlapping sequences and directing the receiver to perform a smooth fade between the two sequences on display.

The second component of the invention is a matching receiver/play-back unit which is capable of using the received super-frames and instructions to manipulate the super-frames to produce the many frames of simulated video, as well as manage any transitions or overlaps between sequences.

### BRIEF DESCRIPTION OF THE DRAWINGS

FIG. 1 illustrates sequential frames of a typical motion picture film of the type to the present invention is applicable.

FIG. 2 illustrates how the frames of FIG. 1 are positioned relative to an actual scene from which the motion picture was taken.

FIG. 3 illustrates a super-frame composite of the frames of FIG. 1.

FIG. 4 illustrates how the frames of are composited into the super-frame.

FIG. 5 is a flow chart illustrating how a video to be processed is divided into super-frame subsequences.

FIG. 6 is a flow chart illustrating the process of compositing video frame subsequences into super-frames in accordance with the invention.

FIG. 7 is a flow chart illustrating the process by which the super-frames are played back as a video facsimile of the original video from which the super-frames were created.

### DESCRIPTION OF THE PREFERRED EMBODIMENTS

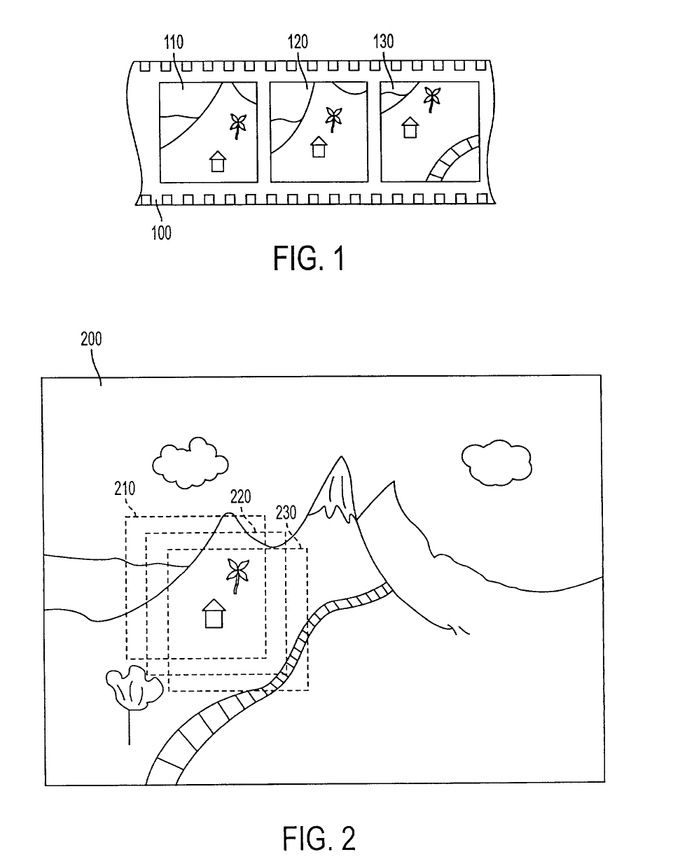

The invention will be explained with reference to a motion picture film as shown in FIGS. 1-4 to facilitate the explanation, because the material depicted by a given frame in a motion picture film can be observed by looking at the individual film frame. It will be understood that the invention is applicable to video motion pictures in the same manner that it is explained with reference to FIGS. 1-3.

FIG. 1 shows a small piece of motion picture film 100, containing three frames, 110, 120 and 130. These three frames show slightly different views of the same scene to represent a film as a camera pans left to right. A motion picture would contain a large number of such images, typically in the range of 24 to 30 frames per second of capture.

Although the frames stand as individual images, they were recorded in sequence from a real scene and represent pieces of the landscape before the photographer. FIG. 2 shows this landscape 200 with the individual frames outlined within the scene. Outline 210 corresponds to image 110; likewise outlines 220 and 230 correspond to images 120 and 130, respectively. In a real film or video many more frames would be captured from this scene, and each could be outlined in a similar fashion. If one had the entire scene before him, then one could re-create the frames by pointing a photographic camera at the same spots as outlined and exposing the film in the same way. In fact, one does not need the entire scene. One only needs the portion of the scene which contains the portion within the outlines 210, 220 and 230. For purposes of simplifying the explanation of the system, changes in the scene, such as the leaves blowing on a tree or the movements of animals or people within a scene while the video is being recorded, are ignored.

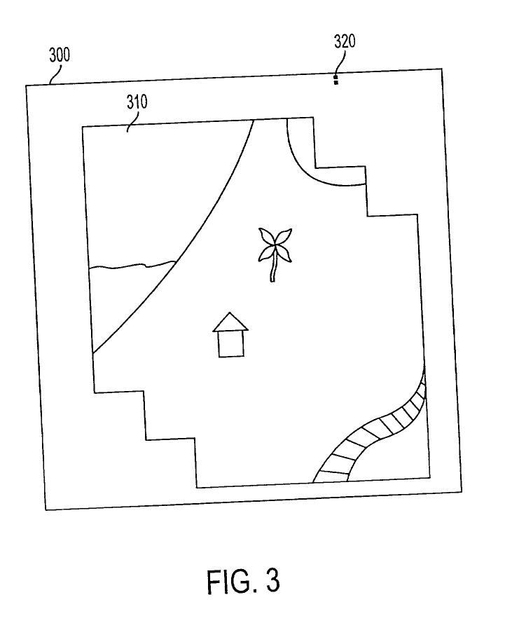

FIG. 3 shows a super-frame 300 which contains a piece of the original scene 200 which contains all the image area within outlines 210, 220 and 230. This comprises area 310. In the preferred embodiment, to work smoothly within existing systems, this super-frame is made rectangular by filling an area 320 around the content area 310. This area 320 would be a solid color, such as “black” to allow for maximum compression of this non-used area, and would be made as small as possible. Alternatively, a system which creates, stores an sends irregular shaped frames could be employed.

The super-frame must combine the elements of the three frames that might not perfectly match. Discrepancies between neighboring areas must be resolved as well as discrepancies within overlapped areas.

One way in which the images may not be aligned is due to camera rotation. The seams between the overlapping frame may not line up. Since rotation of the camera is an unusual technique, and the non-alignment is most likely an error in the image recording technique, the preferred embodiment will first compensate and “undo” the effect of any camera rotation.

Another way in which the images may not be aligned is due to camera “zoom”. A zoom-in will magnify the scene and a zoom-out will de-magnify the scene. A zoom will mean that objects along a seam between two images will not be the same size and will not line up along the seam. To correct this misalignment, the images will all be retroactively zoomed to the same magnification before compositing. In the preferred embodiment, the image with the largest zoom (smallest outline in the original real-life scene) will set the scale against which all others will be zoomed. Other choices, such as the smallest zoom or the central or average value could be used to set the scale. The important function is to match the frame scales before compositing. After compositing, the whole super-frame may be reduced or increased in size to manage the amount of data required to encode it.

Another discrepancy that may require resolution results from the time-dependent nature of the images. Something within the scene may have changed between exposures, or lighting may change, or the camera focus might be adjusted. These occurrences all give rise to changes within the images that is not position or zoom dependent.

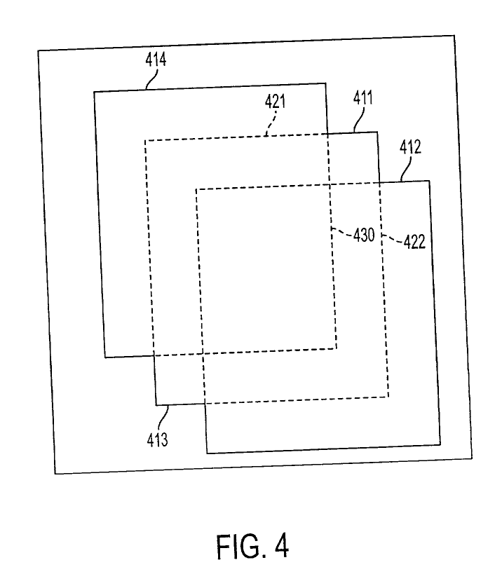

FIG. 4 shows the same super-frame as FIG. 3, but divided into sub-area by the original frame outlines. Some regions have only one frame covering them so there are no discrepancies (411, 412, 413 and 414). Other areas have two frames covering them (421 and 422). One area, 430 has all three frames covering it. Several methods could be used to resolve discrepancies in areas in which two or more frames overlap, including averaging, or weighted average, or taking median values or highest brightness, etc. Each has some merit and some disadvantage (usually blurring). The preferred embodiment chooses a simple “greedy” method to blur and conserve CPU load. This method takes the frames in order and allows each to cover as much area as possible. Subsequent frames fill in only those areas which are not already covered by the previous frames. In this way, Frame 110 would fill in areas 414, 421 and 430. The next frame, 120 would fill in area 411, 422 and 413—the areas within frame 120 which were outside of frame 110. Lastly, Frame 130 would fill in the area 412—the only area not already filled by the previous frames 110 and 120.

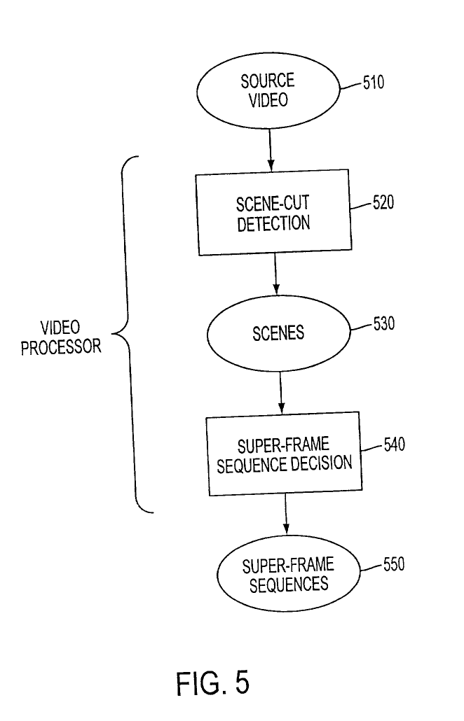

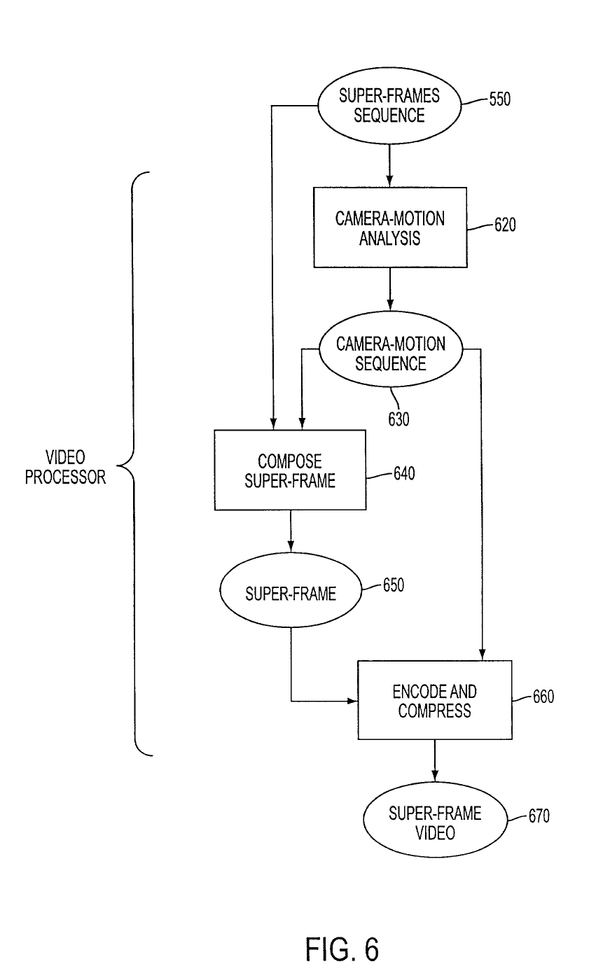

FIGS. 5 and 6 show the steps performed by a video processor in the processing of a source video into super-frames and super-frame animation information. As shown in FIG. 5, the source video 510, provided by a video camera, is passed to scene-cut detector module 520. Here, the frames are examined to note where major changes in the input source video occur. These changes, called scene cuts, might be a change from an inside scene to an outside scene or a cut to a different camera angle of the same scene. It is desirable that any super-frame subsequence not span over a scene cut, but be entirely contained within one scene between scene cuts. A sequence of frames between scene cuts is called a scene. Accordingly the source video 510 is divided into scenes 530 at the scene cuts. This division of the scene video by scene cut is the highest level division of the source video. The scene cuts are preferably detected by a technique such as that described in co-pending application serial No. 60/278,443 entitled Method and System for the Estimation of Brightness Changes for Optical Flow Calculations filed Mar. 26, 2001, invented by Max Griessl, Marcus Wittkop and Siegfried Wonneberger. The system as described in this application analyzes brightness changes from frame to frame. The brightness changes are classified into different classifications one of which is referred to as a scene shift, which is another term for a scene cut. This co-pending application is hereby incorporated by reference.

The output of the scene-cut detection is a sequence of scenes 530, each containing a number of frames which are sequential in time and space. The sequence of frames of a scene are called a scene sequence. These scenes are then passed to a process 540, that decides how to divide a scene sequence into subsequences each corresponding to a super-frame.

There are many viable strategies for dividing a scene into super-frame subsequences. A super-frame might contain a longer subsequence of frames if the subject matter is relatively static, and might be made short if there is enough change within the range of the super-frame subsequence to induce a large error. This might happen in the case of a fast pan or fast zoom. In the preferred embodiment, the scenes are divided into super-frame subsequences of 5-seconds duration. If the time duration of the super-frame subsequences is not integral to the duration of the scene sequence of which the super-frame subsequences are a part, the super-frame subsequences are extended equally so that their time duration is integral to the duration of the scene sequence. The term “integral to” as used in this description means that the value divides evenly, with no remainder, into a second value that the first value is integral to. If this operation makes the super-frame subsequences longer than 7 seconds in duration then the time duration of the super-frame subsequences is shortened to make the time duration of the super-frame subsequences integral to the duration of the scene. If the scene is shorter than 7 seconds then the entire scene sequence will become a single super-frame.

After the super-frame subsequences have been decided upon, each super-frame subsequence is lengthened by one second by addition of frames from the preceding subsequence, or the succeeding subsequence, or both, to provide a one-second overlap between each super-frame subsequence in a scene. This overlap is used to cross fade between super-frame subsequences in the playback as will be described below.

The output of the super-frame sequence decision block 540 is a set of super-frame subsequences 550, each subsequence containing a contiguous set of original video frames.

The processing of these subsequences of frames is carried out as shown in FIG. 6 with the input of the super-frame subsequences of frames 550. Each subsequence 550 is analyzed for camera motion in block 620, and the camera motion is stored as part of the camera data 630 for later processing. The camera data 630, in addition to the camera motion data, also includes the number of frames going into the super-frame, the frame rate, and the time of each frame relative to the other frames in the sequence including the explicit times of any missing frames or gaps in the sequence. Digital videos often do not contain frames for all of the frame time slots and the explicit time of any such missing frame is included in the camera data to enable the system to more easily use video sources with dropped frames. The term “camera motion”, includes physical motion while walking or on a moving platform, as well as movement around a vertical axis (pan) or an elevation change (vertical pan) or rotation about the lens axis (rotation). Further, changing the camera parameters such as the zoom of the lens is also counted and is treated in a manner similar to moving the camera toward or away from the subject of the image.

The camera motion is determined on a frame-by-frame basis, but consistent camera movement over many frames may be detected and described in the camera data. For instance, a horizontal pan may proceed in a constant rotation over several seconds. This can be described as a single sweep or as many frame-by-frame movements. Either method is acceptable.

In the preferred embodiment, the camera motion is determined by first generating dense motion vector fields representing the motion between adjacent frames of each sequence. The dense motion vector fields represent the movement of image elements from frame to frame, an image element being a pixel-sized component of a depicted object. When an object moves in the sequence of frames, the image elements of the object move with the object. The dense motion vector fields may be generated by the method described in co-pending application Ser. No. 09/593,521 filed Jun. 14, 2000, entitled System for the Estimation of Optical Flow. This application is hereby incorporated by reference.

To detect the camera motion from the dense motion vector fields, the predominant motion represented by the vectors is detected. If most of the vectors are parallel and of the same magnitude, this fact will indicate that the camera is being moved in a panning motion in the direction of parallel vectors and the rate of panning of the camera will be represented by the magnitude of the parallel vectors. If the motion vectors extend radially inwardly and are of the same magnitude, then this will mean that the camera is being zoomed out and the rate of zooming will be determined by the magnitude of the vectors. If the vectors of the dense motion vector field extend radially outward and are of the same magnitude, then this will indicate that the camera is being zoomed in. If the vectors of the dense motion vector field are primarily tangential to the center of the frames, this means that the camera is being rotated about the camera lens axis. The computer software, by analyzing the dense motion vector fields and determining the predominant characteristic of the vectors, determines the type of camera motion occurring and the magnitude of the camera motion.

The camera motion as described above is motion intentionally imparted to the camera to make the video such as panning the camera or zooming the camera. In addition to this intentional camera motion, the camera may be subject to unintentional motion such as camera shake. Also the camera may be subject to excessive motion such as the camera being panned or zoomed too rapidly. These unintentional and/or excessive camera motions typically occur when the video is shot by a non-professional cameraman, which will often occur in the use of this invention such as in real estate or personal property sale promotions. The effects of this undesirable camera motion in the video would detract from the quality of the video product being produced. In accordance with the preferred embodiment, as part of the camera motion analysis 650, the video is processed to eliminate the effect in the video of camera shake or other similar unintentional camera motion and excessive camera motion. This action generates a new sequence of video frames from the original set of frames so that the new set of frames appear as if shot with a steady camera hand and with a moderate panning or zooming rate. This video processing to eliminate the effect of unintentional motion and/or excessive motion may be carried out by the system disclosed in a copending application Ser. No. ______, (attorneys docket no. 36719-176669) filed Dec. 4, 2001, entitled Post Modification Of Video Motion In Digital Video (SteadyCam) invented by Max Griessl, Markus Wittkop, and Siegfried Wonneberger. This application is hereby incorporated by reference. Alternatively the effect of undesirable camera motion may be eliminated by using the technique disclosed in U.S. Pat. No. 5,973,733 issued Oct. 26, 1999 to Robert J. Gove. This patent is hereby incorporated by reference.

Following detection of the camera motion, in the super-frame composition block 640, the original frames of each subsequence are used to compose a super-frame 650 that contains the areas of the scene that are within all the original frames. The camera motion values are used in this process as they provide the data as to how to line up and scale the various frames so the seams will match. The camera motion data may be used to provide a coarse alignment followed by a fine alignment carried out by comparing the pixel patterns at the seams between the frames

The output super-frames 650 are passed, along with the camera motion data 630, to be encoded and compressed in module 660. Image compression techniques such as JPEG or other systems are used to compress the super-frames. The compression of the super-frames may involve techniques that use economies of similarities with previous super-frames, such as MPEG or may be wholly intra-frame coding such as JPEG or codebook techniques.

In the preferred embodiment, lossy coding is used for the images, but lossless encoding is used for the camera data. For the lossless encoding, any acceptable technique, including Huffman or code-dictionary techniques may be employed. In the preferred embodiment, to reduce the CPU load on the playback side, camera motion data is transformed to the perspective of the playback system so that the transformed camera motion data will be in reference to the coordinates of the playback system instead of the coordinates of the source.

The combined compressed data, super-frames and associated transformed camera motion 670, are outputted and constitute the source for the playback system. It may be stored or immediately transported as generated.

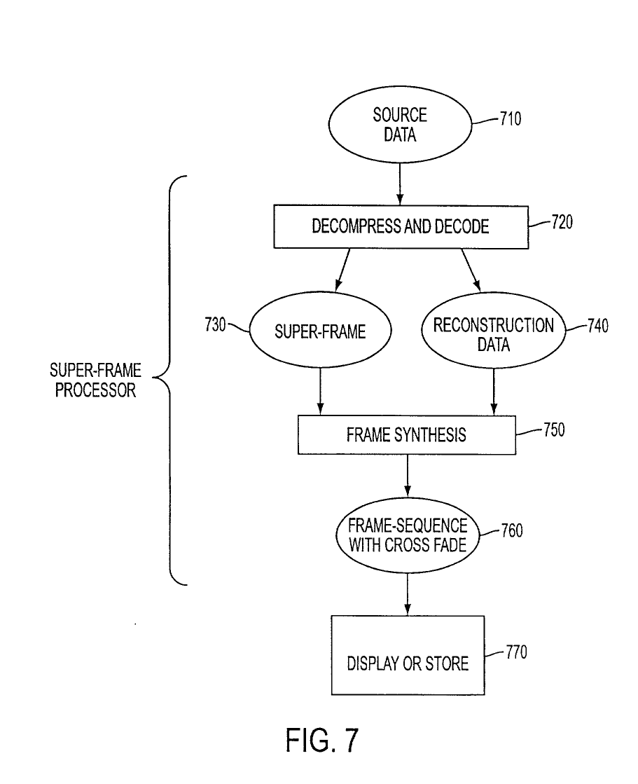

In the playback process illustrated in FIG. 7, a video data processor, called a superframe processor, performs the converse to the process of FIG. 6. The source data 710, which corresponds to the output data 670, is decompressed and decoded in module 720. The outputs of this process are a super-frames 730 and the reconstruction data 740. The reconstruction data is essentially the camera motion data 630, but in the preferred embodiment, the camera motion data has been transformed into the coordinate space of the super-frames 730 to ease the computation of the playback unit. The two pieces of data for each super frame comprising a super-frame 730 and reconstruction data 740 derived from camera data 630 are passed into the frame synthesis module 750, which proceeds to apply the reconstruction data 740 to extract out the appropriate sub-area of the super-frame 730 for each desired output frame. It also applies any post-extraction manipulation such as zoom, rotate or brightness adjustments, as directed by the reconstruction data 740 to create a frame similar to the original video source frame. The reconstruction data also contains other information essential to practical systems. This other information includes information about the number of output frames to be created from the super-frame, the frame-rate (time spacing of the output frames) as well as the time instant that each output frame should be displayed. The number of output frames normally will correspond to the number of input frames in the camera data plus any missing frames.

The time duration of a subsequence from a single super-frame is adjustable by the user, but is recommended to be about 6 seconds including a one second overlap mentioned above. The adjoining super-frame subsequences are likely to be visually different and the transition from one to the next would be noticeable. In the preferred embodiment, a 1-second cross fade is used to transition from one super-frame subsequence to the next in the playback of the super-frame data. For this purpose the subsequences have a one second of overlap with the previous subsequence, four seconds which are unique with no overlap and a one second overlap with the sequence to follow. Because it may be undesirable to fade between some super-frame sequences, this overlap need not be fixed. The instructions on whether to fade and the length of the fade can be passed as part of the reconstruction data.

The output of the frame synthesis 750 is a sequence of frames 760 which are ready to be stored as a video, or immediately displayed in a streaming application, as shown by process block 770. If the frames are to be stored, then they are stored after the cross-fade between subsequences has been completed so that the frames are in the same visual state as if they were to be displayed.

In the invention in its simplest form, the playback system uses the camera motion data representing the actual motion of the camera when the original video was generated to create a facsimile of the original video from which the super-frames were produced. Alternatively the operator may introduce selected new camera motion into the camera data in the display process to make a zoom in, a zoom-out or a different panning motion than represented by the original camera data in the display generated from the super-frames.

The system of the invention as described above provides an effective technique of compressing video data when the video only includes a limited amount of action to be depicted as is the case in many advertising videos and educational videos.

The above description is a preferred embodiment of the invention and modification may be made thereto without departing from the spirit and scope of the invention, which is defined in the appended claims.

What is claimed is:

1. A video display system comprising a video source to provide a video comprising a set of video frames, a video processor to separate said set of video frames into input subsequences and to combine the frames of the input subsequences into super-frames comprising composits of the input subsequences, a super-frame processor arranged to receive said super-frames and to generate output subsequences of video frames from said super-frames corresponding to the input subsequences of frames from which the corresponding super-frames were composed, and a video display device connected to display said output subsequences in sequence as a facsimile of said video.

2. A video display system as recited in claim 1 wherein said video processor detects scene cuts in said video, said input subsequences being selected so as not to include a scene cut between the frames of a given input subsequence.

3. A video display system as recited in claim 2 wherein said video processor produces said input subsequences by dividing the scenes between said scene cuts into said input subsequences.

4. A video display system as recited in claim 1 wherein said super frame processor generates an output sequence from said output subsequences with cross fading from the end of each preceding output subsequence to the beginning of the next succeeding output subsequence.

5. A video display system as recited in claim 1 further comprising a video camera motion detection system which detects the motion of a video camera when generating said video, said video processor positioning the frames of said video in said super-frames in accordance with the detected camera motion.

6. A video display system as recited in claim 5 wherein said super-frame processor produces the frames of said output subsequences in accordance with said detected camera motion.

7. A system as recited in claim 5 wherein said video camera motion detection system detects camera shake and/or excessive motion of said camera and generates from said set of video frames a new sequence of video frames in which the effects of camera shake and/or excessive motion are eliminated.

8. A video compression system comprising a video source, and a video processor connected to receive a video from said video source, said video processor being operable to detect the scene cuts in the received video, to separate the frames of said received video into sequences wherein each sequence does not include a scene cut, and to combine the frames of each sequence into at least one composite of the frames of such sequence.

9. A video compression system as recited in claim 8 wherein said video processor divides the scenes between the pairs of adjacent scene cuts into subsequences, said composits each comprising the frames of a subsequence.

10. A display method comprising generating a video with a video camera which is subjected to camera motion, dividing said video into input subsequences of frames, combining the frames of each input subsequence into a super-frame comprising a composit of the frames of such subsequence, generating output subsequences of frames from said super-frames corresponding to said input subsequences, and displaying said output subsequences in sequence as a facsimile of said video.

11. A display method as recited in claim 10 wherein the step of dividing said video into input subsequences is carried out by detecting scene cuts in said video and dividing the scenes between said scene cuts into said input subsequences whereby said input subsequences do not include scene cuts.

12. A display method as recited in claim 10 wherein said output subsequences are displayed in sequence by fading from the end of each preceding output subsequence into the beginning of the next succeeding output subsequence.

13. A display method as recited in claim 10 further comprising detecting the motion of said video camera and positioning the frames of each input subsequence in the corresponding super-frame in accordance with the detected camera motion.

14. A display method as recited in claim 13, further comprising deriving the frames of said output subsequences from said super-frames in accordance with the detected camera motion.

15. A display method as recited in claim 13 wherein the step of detecting camera motion includes detecting camera shake and/or excessive camera motion and further comprises generating from said video a new sequence of video frames in which the effects of camera shake and/or excessive camera motion are eliminated.
